(19) United States
(12) Patent Application Publication
(10) Pub. No.: US 2002/0153647 A1
(43) Pub. Date: Oct. 24, 2002

(54) Hydraulic mount and control method

(75) Inventors: Thomas A. Baudendistel, Farmersville, OH (US); Sanjiv G. Tewani, Lebanon, OH (US); Mark W. Long, Bellbrook, OH (US); James E. Dingle, Cincinnati, OH (US)

Correspondence Address: DELPHI TECHNOLOGIES, INC., Legal Staff, Mail Code: 482-204-450, P.O. BOX 5052, 1450 W. Long Lake, Troy, MI, 48098, US

(73) Assignee: DELPHI TECHNOLOGIES INC.

(21) Appl. No.: 09/840,225

(22) Filed: Apr. 23, 2001

(51) Int. Cl. F16M 5/00

(52) U.S. Cl. 267/140.14

(57) ABSTRACT

A hydraulic mount control system for a vehicle including at least one hydraulic mount, each mount including a hollow body defining a fluid-filled chamber. A pressure sensor is positioned to sense the fluid pressure in the chamber and generate a pressure signal. A control unit is electrically connected to the pressure sensor. The control unit is adapted to generate an electric control signal in response to the pressure signal from the pressure sensor and a control device is responsive to the electric control signal for controlling the hydraulic mount.

### TECHNICAL FIELD OF THE INVENTION

The present invention relates generally to a mounting arrangement for an automotive power unit such as a hydraulic mount for vibration damping. More particularly, the invention is directed to a hydraulic mount assembly that features a sensor positioned to sense pressure in the mount, the pressure values of which are used by a control unit and device to alter the control characteristics of the mount.

### BACKGROUND OF THE INVENTION

It is desirable to provide modern vehicles with improved operating smoothness with respect to damping and/or isolating the engine vibrations of the vehicle. In this respect, a variety of mount assemblies are presently available to isolate vehicle vibrations, such as for automobile and truck engines and transmissions. Currently, many vehicles incorporate mount assemblies that combine the advantageous properties of elastomeric materials with hydraulic fluids. A hydraulic mount assembly of this type typically includes a reinforced, hollow rubber body that is closed by a resilient diaphragm so as to form a cavity. This cavity is separated into two chambers by a plate. The chambers are in fluid communication through a relatively large central orifice in the plate. The first or primary chamber is formed between the partition plate and the body. The secondary chamber is formed between the plate and the diaphragm.

The conventional hydraulic mount assembly can contain a decoupler positioned in the central orifice of the plate that reciprocates in response to vibrations. The decoupler movements alone accommodate small volume changes in the two chambers. At certain small vibratory amplitudes and high frequencies, fluid flow through the outer track between the chambers is substantially avoided and hydraulic damping does not occur. In this manner, the decoupler functions as a passive tuning device.

In addition to the large central orifice, a hydraulic mount can further include an outer track with a smaller flow passage. The track in combination with the decoupler provides another passive tuning component. This assembly, with respect to small amplitude vibrating inputs, produces little or no damping. On the other hand, large amplitude inputs produce high-volume, high velocity fluid flow through the track, producing a high level of damping force. The operational characteristics of the hydraulic mount are entirely dependent upon the design of the orifice and track in addition to the characteristics of the damping fluid and elastomeric portions of the mount. As such, while varying amounts of damping are achieved with this design, changing the characteristics of the mount is not possible.

Active vibration control has more recently become known in the art. Basically, a velocity sensor measures the amount of vibration of the mount or vibration of the vehicle. Typically an output signal proportional to a measurable motion (such as displacement) of the structure, is produced by the sensor. A processor/controller processes the sensor-generated output signal so as to produce a control signal, which is applied to the mount.

The three basic components of an active vibration isolation system are a motion sensor (e.g., a motion transducer), a processor and a control device. The sensor responds to vibratory motion by converting the vibratory motion into an electrical output signal that is functionally related to, e.g., proportional to, a parameter (e.g., displacement, velocity or acceleration) of the experienced motion. An accelerometer, for example, is a type of sensor wherein the output is a function of the acceleration input; the output is typically expressed in terms of voltage per unit of acceleration. The most common processor is a microprocessor that combines A/D conversion and a control signal derivation section. The control device can be any one of a number of electrically controllable devices designed to control damping in the hydraulic mount.

More recently, developments in hydraulic mount technology have been employed in electronic control of the mount. This type of mount represents an improvement over previous mounts in that it is responsive to sensed vehicle operating conditions. In this type of mount, an additional active control aspect to that of passive control is provided the mount. The tuning is accomplished by the use of a variable gate or valve for changing the size of the opening to the passage or track between the two chambers thus controlling the flow of damping fluid therethrough. In the conventional approach, a velocity sensor is employed to provide information to the electronic control unit. The sensor measures relative velocity (RV) across the mount. The control unit uses RV information to control the damping of the mount and therefore the stiffness and resistance to movement of the mount.

An alternate approach to active tuning with valves includes the use of an electro-rheological fluid (ER) or a magneto-rheological (MR) fluid disposed in the first and second chambers. In this approach, a number of conductive plates form the partition between the chambers. The plates are provided with an electrical potential thus controlling the flow of fluid between the chambers. The plates of the partition include a number of small flow apertures. In this case modulation of damping is possible by electrically varying the viscosity of the fluid in the case of an ER fluid or the sheer resistance of the fluid in the case of a MR fluid. These ER/MR mounts include a velocity sensor positioned to measure the relative velocity (RV) across the mount to provide velocity information to a control unit. In other systems, additional sensors are positioned to measure RV in various portions of the vehicle, such as adjacent the driver. However, such control systems using velocity sensors can be complex and expensive.

It would be desirable to provide a hydraulic mount with continuously variable damping characteristics actively controlled by a simple and inexpensive sensor and control unit arrangement.

### SUMMARY OF THE INVENTION

One aspect of the present invention provides a hydraulic mount control system for a vehicle including at least one hydraulic mount, each mount including a hollow body defining a fluid-filled chamber. A pressure sensor is positioned to sense the fluid pressure in the chamber and generate a pressure signal. A control unit is electrically connected to the pressure sensor. The control unit is adapted to generate an electric control signal in response to the pressure signal from the pressure sensor and a control device is responsive to the electric control signal for controlling the hydraulic mount.

Other aspects of the present invention provide the hollow body with an elastomeric portion and a diaphragm portion. The pressure sensor is positioned in the chamber. The fluid includes a mount fluid. The control device is positioned in the chamber. The control device is positioned in the chamber so as to separate the chamber into an upper and a lower sub-chamber. The control device is adapted to control the flow of fluid between the upper and lower sub-chambers. The control device includes an electrically controlled valve positioned in the chamber between the upper and lower sub-chambers. The valve can be a variable diameter orifice, the orifice being in communication with the upper and lower sub-chambers. The valve is located on a plate, the plate being positioned between the upper and lower sub-chambers.

Other aspects of the invention provide an electro-rheological fluid as the fluid. The system can include an electro-rheological control device adapted to control the flow of electro-rheological fluid between the upper and lower sub-chambers. The electro-rheological device includes a pair of spaced plates located between the upper and lower sub-chambers. The plates can control the apparent viscosity of the electro-rheological fluid passing adjacent thereto when a voltage is applied across the plates.

The system can include a magneto-rheological fluid. Other aspects of the system include where the control device includes a magneto-rheological control device adapted to control the flow of the magneto-rheological fluid between the upper and lower sub-chambers. The magneto-rheological device can include an annular coil positioned adjacent at least one passageway through a plate, the plate being positioned between the upper and lower sub-chambers. The coil can be adapted to impart an increased shear resistance to the magneto-rheological fluid when a current is passed through the coil.

Another aspect of the present invention include a method of controlling a fluid-containing mount including sensing a pressure of the mount fluid, generating a pressure signal corresponding to the sensed pressure, generating an electric control signal corresponding to the pressure signal and controlling the flow of mount fluid in the mount responsive to the electric control signal. The method can further include subtracting a percentage of signal from the generated electronic control signal, the percentage corresponding to an additional amount of pressure produced by the control of the mount fluid.

Another aspect of the present invention provides a hydraulic mount control system for a vehicle including means for sensing a pressure of a mount fluid, means for generating a pressure signal corresponding to the sensed pressure, means for generating an electric control signal corresponding to the pressure signal and means for controlling the flow of the mount fluid in the mount responsive to the electric control signal. The system can further include a means for subtracting a percentage of signal from the generated electronic control signal, the percentage corresponding to an additional amount of pressure produced by the control of the mount fluid.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram conceptually depicting arrangement of the present invention;

FIG. 2 illustrates a cross-sectional view of one embodiment of a MR mount of the present invention; and

FIG. 3 illustrates a cross-sectional view of another embodiment of a mount of present invention.

### DETAILED DESCRIPTION OF THE PRESENTLY PREFERRED EMBODIMENTS

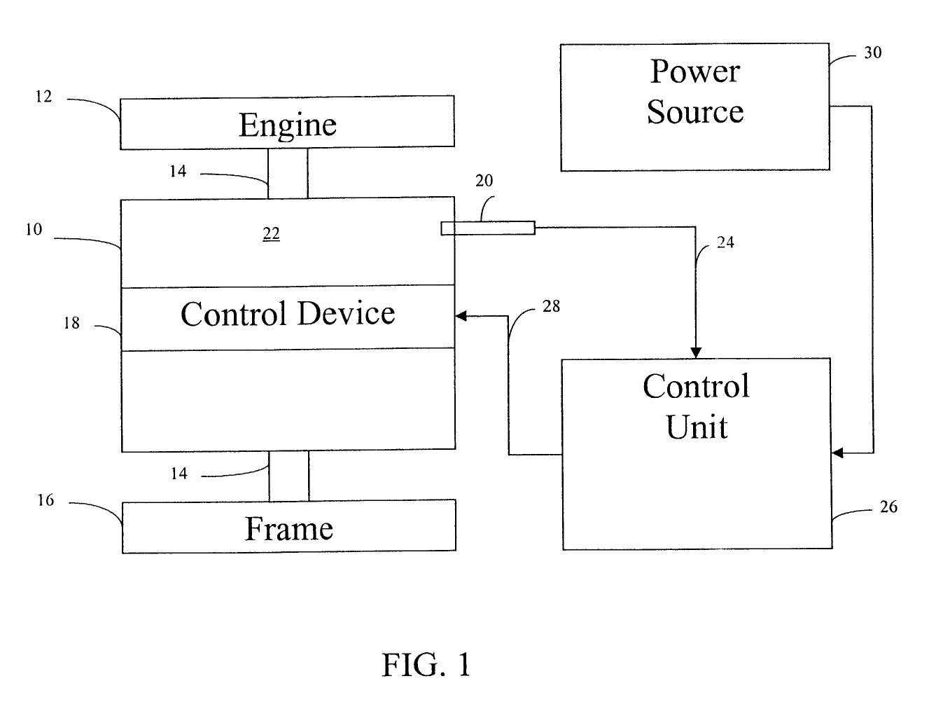

Referring to the drawings, illustrated in FIG. 1 is a generalized depiction of one embodiment of a mount and control system of the present invention. Mount assembly 10 is attached to an engine 12 or transmission by a fastener 14, for example, a stud, or the like. The mount assembly 10 is similarly attached to a vehicle frame 16 such that the mount is interposed between engine 12 and frame member 16. The mount assembly 10 includes control device 18. The control device 18 can be any electrically controlled device that provides the capability of altering the ability of the mount to resist movement. In other words, the device 18 has the capability of changing the damping characteristics, or the like, of the mount. Thus, the device 18 can include, for example, any one or more of a variable valve device, an electrical field-generating device, such as a coil, or other such devices.

The mount assembly 10 includes a pressure sensor 20 positioned to sense the pressure of a hydraulic fluid, ER fluid, MR fluid, or the like, housed within a chamber 22 within the mount 10. Pressure in the chamber 22, changes relative to the RV across the mount. Pressure sensed by the sensor 20 generates a signal 24 that is communicated to a control unit 26.

In response to the input signal 24 from the sensor 20 the control unit 26, using electricity from power source 30 generates a signal, voltage or current amount 28. The control signal 28 controls the control device 18 of the mount 10.

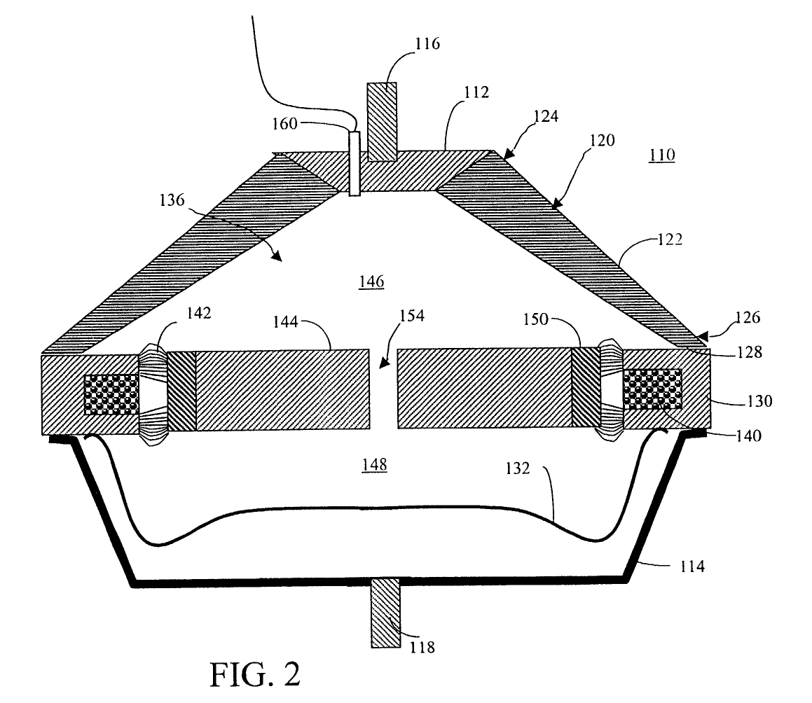

Referring to the drawings, illustrated in FIG. 2 is an embodiment of a MR mount 110 of the present invention. This mount assembly 110 is particularly adapted for mounting a component, such as an internal combustion engine or transmission to the frame of the vehicle. The mount assembly 110 can be used in applications other than engine or transmission mounts, where control of vibrations is desired.

Magneto-rheological (MR) fluids comprise small soft-magnetic particles dispersed within a liquid carrier. Typical particles include carbonyl iron, or the like, having various shapes, but which can be spherical, and which exhibit mean dimensions of between about 0.0000001 m to 0.000500 m. The carrier fluids include various known hydraulic oils, and the like. These MR fluids exhibit a thickening behavior (a rheology change), sometimes referred to as an “apparent viscosity change”, upon being exposed to a magnetic field of sufficient strength. The higher the magnetic field strength to which the MR fluid is exposed, the higher the differential pressure (flow restriction or damping force) that can be achieved within the device.

The mount assembly 110 shown in FIG. 1 can include a metal mounting member or insert 112 and a metal base plate 114. The insert 112 and base plate 114 can include a respective mounting stud 116, 118. The studs 116, 118 project outwardly from the insert 112 and base plate 114 for attachment respectively to an engine/transmission and an engine/transmission supporting cradle or frame member of a vehicle.

A hollow, flexible body 120 can generally interconnect the insert 112 and base plate 114. The body 120 can be formed of an elastomeric material, such as natural or synthetic rubber. In the illustrated embodiment, the body 120 can include an upper portion 122 comprising an elastomeric wall. The elastomeric wall 122 can attach at one end 124 to the metal insert 112. The other end 126 of the elastomeric wall 122 can attach to a first surface 128 of ring member 130. The body 120 further includes a diaphragm portion 132, which can be attached to a second surface 134 of the orifice ring 130. In this manner, the body 120 generally defines a fluid chamber 136. The fluid chamber 136 contains a MR fluid.

The orifice ring 130 can include a groove 138 formed in an inner portion. An electromagnetic coil 40 can be disposed in the groove 138. The coil 140 can be electrically connected to a current driver (not shown), or the like, to produce an electrical field depicted at 142. As is known in the art, a system controller (not shown) controls the driver. In one embodiment, the system controller takes the form of a microprocessor in a control circuit, which controls the current to the driver using sensed pressure to determine the appropriate control action.

A disk shaped orifice plate 144 can divide the fluid chamber 136 into an upper or “pumping” chamber 146 and a lower or “receiving” chamber 148. The orifice plate 144 can be formed of a rigid plastic or metal material. A metal ring or rim 150 can be located about the outer periphery of the orifice plate 144. The rim 150 can be positioned adjacent the coil 140 in the ring member 130 and spaced apart from the coil by a gap. In this manner, when the coil 140 is energized, an electromagnetic field 142 extends through the gap between plate 144 and coil 140. A weep hole 154 can be formed through the orifice plate 144 in fluid communication with the upper chamber 146 and lower chamber 148 for temperature compensation can be formed at or near the center of the orifice plate. The weep hole 154 does not affect the overall operation of the mount 140.

In operation, stud 116 is attached to engine or transmission and stud 118 is attached to a frame portion of a vehicle. When the engine is at an idle speed, for example, small amplitude/low velocity vibrations are typically produced. These vibrations are detected as changes in fluid pressure in the chamber 146 and appropriate signals are sent from a pressure sensor 160 to the controller unit 26. In response, the controller can produce a signal that can result in no or a small current or like control signal being applied to the coil 140.

When coil 140 produces little or no electrical fields the MR fluid produces very little shear resistance. As a result, fluid flows proportionally to pressure in response to changes in fluid pressure in chamber 146 and the mount 110 exhibits relatively soft characteristics that effectively isolate transfer of vibrations of the engine to the vehicle frame. The characteristics of the mount 110 are a function of the initial rheological properties of the fluid and the elastomeric portions 122, 132 of the mount.

As the mount 110 is exposed to an increase of vibrations, the increased load placed on the insert portion 112 of the mount 110 creates a condition of increased fluid pressure in the upper chamber 146, which is detected by the pressure sensor 160. In the event that the coil 140 is not in an energized condition, the movement of the fluid is proportional to the fluid pressure in the chamber 146. However, when the controller increases the current (and thus, the density of the magnetic field) in the coil 140, the shear resistance of the MR fluid is increased. It will be understood that the current may be provided in an amount proportional to the sensed pressure value. Accordingly, the movement of the fluid is resisted proportionally with the current and resulting flux density 142 created by the coil 140. Thus, the resistance to movement of the mount 110 is continuously infinitely variable so as to match the operating conditions of the engine and provide appropriate motion isolation and control of engine movement. It will also be understood that the controller may be adapted to compensate for an increase in pressure in the chamber 146 due to an increase in flow resistance of fluid imparted by the control effect of the higher apparent viscosity of the MR fluid. In this case, a predetermined or calculated percentage of the current can be subtracted to compensate for the additional pressure due to control of the MR fluid, the remainder of the current and flow resistance directed to controlling velocity only.

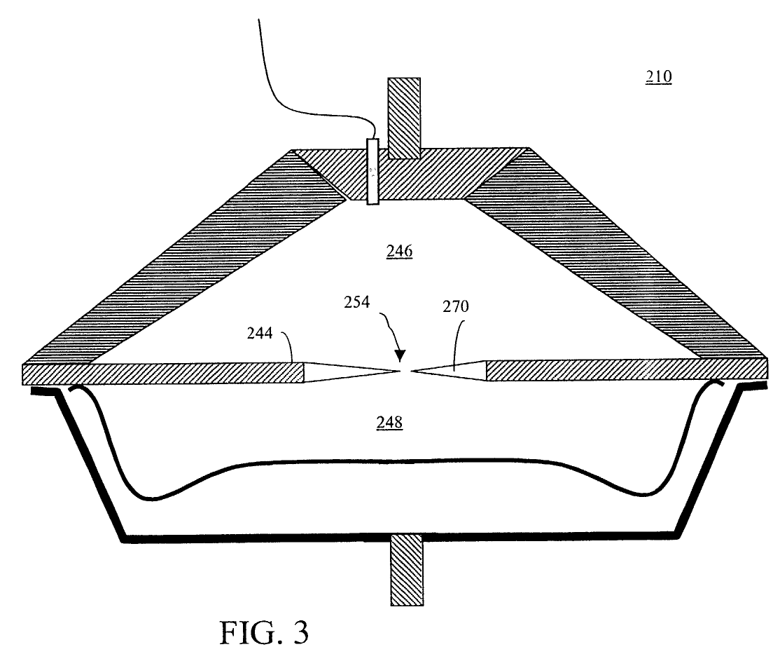

Referring again to the drawings, illustrated in FIG. 3 is another embodiment of a mount 210 of the present invention. The embodiment illustrated differs from that shown in FIG. 2 by including a modified orifice plate 244 comprising a control valve 270. In particular, the orifice plate 244 includes a narrow passageway 254 for allowing fluid flow between a first chamber 246 and a second chamber 248. The orifice plate 244 further includes a movable valve member 270. The valve member 270 can be selectively enabled or disabled for permitting or inhibiting the fluid communication between the two chambers 246, 248 through the passageway 254.

While the embodiment of the invention disclosed herein is presently considered to be preferred, various changes and modifications can be made without departing from the spirit and scope of the invention. The scope of the invention is indicated in the appended claims, and all changes that come within the meaning and range of equivalents are intended to be embraced therein.

1. A hydraulic mount control system for a vehicle comprising:
at least one hydraulic mount, each mount including a hollow body defining a fluid-filled chamber;
a pressure sensor positioned to sense the fluid pressure in the chamber and generate a pressure signal;
a control unit electrically connected to the pressure sensor, the control unit adapted to generate an electric control signal in response to the pressure signal from the pressure sensor; and
a control device responsive to the electric control signal for controlling the hydraulic mount.

2. The system of claim 1 wherein the hollow body includes an elastomeric portion and a diaphragm portion.

3. The system of claim 1 wherein the pressure sensor is positioned in the upper chamber.

4. The system of claim 1 wherein the fluid includes a mount fluid.

5. The system of claim 4 wherein the control device is positioned in the chamber.

6. The system of claim 1 wherein the control device is positioned in the chamber so as to separate the chamber into an upper and a lower sub-chamber.

7. The system of claim 6 wherein the control device is adapted to control the flow of fluid between the upper and lower sub-chambers.

8. The system of claim 7 wherein the control device includes an electrically controlled valve positioned in the chamber between the upper and lower sub-chambers.

9. The system of claim 8 wherein the valve includes a variable diameter orifice, the orifice being in communication with the upper and lower sub-chambers.

10. The system of claim 9 wherein the valve is located on a plate, the plate being positioned between the upper and lower sub-chambers.

11. The system of claim 7 wherein the fluid includes an electro-rheological fluid.

12. The system of claim 9 wherein the control device includes an electro-rheological control device adapted to control the flow of electro-rheological fluid between the upper and lower sub-chambers.

13. The system of claim 12 wherein the electro-rheological device includes a pair of spaced plates located between the upper and lower sub-chambers.

14. The system of claim 13 wherein the plates control the flow properties of one of the electro-rheological and magneto-rheological fluid passing adjacent thereto when a voltage is applied across the plates.

15. The system of claim 7 wherein the fluid includes a magneto-rheological fluid.

16. The system of claim 11 wherein the control device includes a magneto-rheological control device adapted to control the flow of the magneto-rheological fluid between the upper and lower sub-chambers.

17. The system of claim 16 wherein the magneto-rheological device includes an annular coil positioned adjacent at least one passageway through a plate, the plate being positioned between the upper and lower sub-chambers.

18. The system of claim 17 wherein the coil is adapted to impart an increased shear resistance to the magneto-rheological fluid when a current is passed through the coil.

19. A method of controlling a fluid-containing mount comprising:
sensing a pressure of the mount fluid;
generating a pressure signal corresponding to the sensed pressure;
generating an electric control signal corresponding to the pressure signal; and
controlling the flow of mount fluid in the mount responsive to the electric control signal.

20. The method of claim 13 further comprising:
subtracting a percentage of signal from the generated electronic control signal, the percentage corresponding to an additional amount of pressure produced by the control of the mount fluid.

21. A hydraulic mount control system for a vehicle comprising:
means for sensing a pressure of a mount fluid;
means for generating a pressure signal corresponding to the sensed pressure;
means for generating an electric control signal corresponding to the pressure signal; and
means for controlling the flow of the mount fluid in the mount responsive to the electric control signal.

22. The system of claim 15 further comprising:
means for subtracting a percentage of signal from the generated electronic control signal, the percentage corresponding to an additional amount of pressure produced by the control of the mount fluid.
